(19) United States
(12) Patent Application Publication
(10) Pub. No.: US 2010/0045925 A1
(43) Pub. Date: Feb. 25, 2010

(54) Sun films

(76) Inventor: Alfredo N. Trujillo, Chicago, IL (US)

Correspondence Address: Alfredo N Trujillo, 4049 West 57th Street, Chicago, IL, 60629, US

(21) Appl. No.: 12/229,194

(22) Filed: Aug. 20, 2008

(51) Int. Cl. G02C 7/10; G02C 9/00

(52) U.S. Cl. 351/47

(57) ABSTRACT

Sun films are able to give the consumer the color they want and the UV protection they need. They are easily adjustable and help block brightness. Sun Films then become a great alternative to buying prescription sunglasses. Sun film come in multiple varieties of solid colors and when applied, help your prescription eyeglasses from scratching. Consumers can also benefit from the unique curved design that each comes in to resemble. Eye glasses. Sun films wrap around your lenses as to be wrinkle free. They also cut down on the brightness of daylight so you are able to see better. Sun films are able to closely match the same size and shape of your prescription eyeglasses. Clean your prescription eyeglasses before applying sun films. Apply the left film for your left eyeglass lens and the right sun film for your right eye lens. A person with poor vision may require help when attaching their adhesive/cling on stick on sun film. Sun films are also thin, flexible. Sun films are come in different sets of colors so you may change them anything at your convenience. Sun films may also be used on clear safety glasses.

Have great vision, even on sunny days with Sun Films. Why would anyone waste money on expensive prescription sunglasses if there was a better alternative? Fancy prescription sunglasses can hurt your wallet but Sun Films are here to help. They provide the same amount of protection as regular sunglasses for a lot less than the cost prescription eyeglasses.

One objective of Sun Films is to provide sun protection to prescription eyeglass holders for less money. Another objective of Sun Films is to weigh less than clip on sunglasses that some consumers attach to they're eyeglasses for sun protection. Sun Films would also have an easy removal system so just taking it out of the package does not ruin it. By using a round cup like container as opposed to a flat square container, Sun Films are easy to lift out of their packaging and put to good use on prescription eyeglasses.

Instead of spending hundreds of dollars on expensive prescription sunglasses, why not get the same results for less money and less hassle. Prescription sunglasses can be hard on your wallet and they can damage easily. If you misplace them or lose them, that's a lot of money down the drain. If you accidentally break them it could cost you. Those sunglasses may also scratch easily and damage your view.

Now there is a better way. Just pick up some replaceable Sun Films from a near by store. Sun Films are easy to apply to your prescription glasses and can be removed and reused again at anytime. There are many different colors to choose from and the great selection of sizes and shapes helps you find the one that fits best on your glasses. Sun Films are perfect for adults and young adults. Plus Sun Films do not rip easily and when the film scratches or you wish to change colors of the film, the customer is able to peel it strait off the package and on to his/her lenses immediately. The film would stick on and peel off easily to insure that no damage is caused to the lenses.

Sun Films will be an excellent choice in choosing prescription sunglasses. Sun Films give the consumer the same amount of protection as regular sunglasses you would pick up at a nearby store. Compared to pricey prescription sunglasses, Sun Films are very inexpensive and they do not provide any excess weight to your prescription eyeglass lenses. When you put Sun Films on your prescription eyeglasses, they will not gain any uncomfortable weight as other clip on sunglasses may do. Sun Films are very thin and may weigh about the same amount as a sheet of paper so when you attach them to your prescription eyeglasses you wouldn't feel a difference. Plus they also help prevent your prescription eyeglasses from getting scratched.

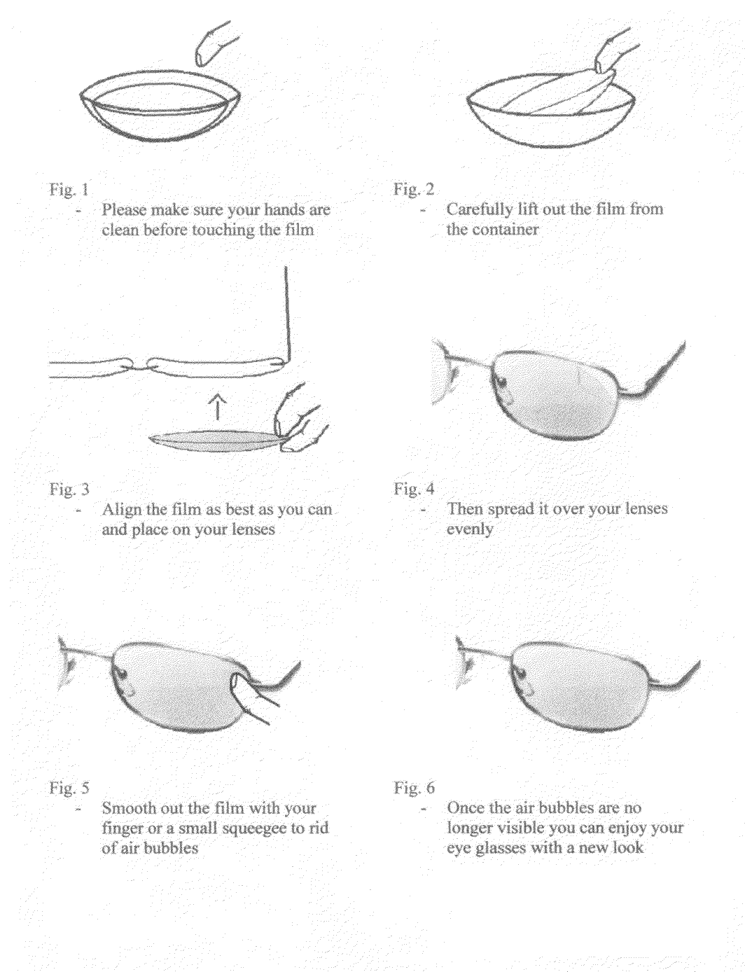

Another wonderful thing about Sun Films is they come in an easy to remove package and are even easier to apply to your glasses. Simply remove the film from the rounded cup like container it comes in with clean hands (see FIGS. 1 & 2). Align a Sun Film to your prescription eyeglass as best as you can and press lightly on your prescription eyeglasses attaching the film (see FIG. 3). Then pull off the protective backing that will block out dust and any debris so it will apply cleanly and spread it over you lenses (see FIG. 4). It is as easy as putting on a small bandage around your finger. All you do is attach a piece and peel off of the backing and attach the rest. Then you can smooth out any air bubbles if you wish with either the small squeegee like device that comes with Sun Films or you can use your finger. After that you're ready to go and continue with your life (see FIGS. 5 & 6).

Sun Films are also a great idea for travel. Since they are inexpensive and disposable you can take them anywhere. You could even carry them in your suitcase or purse and put them on when ever you need them. Young adults will love them too because they come in different colors so they match any style and look good with any outfit. Sun Films come in different shapes and sizes so they can match small round prescription eyeglasses or even big square eyeglasses. There is also a size made special for clear safety glasses so even when you have a project to work on outside the glaring sun can no longer stop you if you have Sun Films on. All you need to do is pick the size and shape that will best fit your prescription eyeglasses and the color you would like to have.

Sun Films can be removed from your prescription eyeglasses at anytime. Sun Films do not leave any unsightly residue on your prescription eyeglasses so you can wear your glasses right after you remove your Sun Films. You can dispose of you old Sun Films and reapply a set of new Sun Films anytime after that.

1. Temporary colored glare shield composed of a thin flexible plastic film that is self-adhered to exteriors of left side and right side of prescription eyeglasses.

2. Temporary colored glare shield as claimed in claim 1, wherein the film is inexpensive and disposable.

3. Temporary colored glare shield as claimed in claim 1, wherein the film does not add excessive weight to the prescription eyeglasses.

4. Temporary colored glare shield as claimed in claim 1, wherein the film is easy to be manually removed from a convenient rounded cup-like container.

5. Temporary colored glare shield as claimed in claim 1, wherein the film has a protective layer attached to the film for easy application that allows the film to go on without dust or debris clinging to the surface and is removed before wearing.

6. Temporary colored glare shield as claimed in claim 1, wherein the film comes with a small squeege-like device that help minimize the air bubbles when the film is adhered to the prescription eyeglasses.

7. Temporary colored glare shield as claimed in claim 1, wherein the film comes in different shapes and sizes to provide the closest fit to the prescription eyeglasses.

8. Temporary colored glare shield as claimed in claim 1, wherein the film may also be used on clear safety glasses.

9. Temporary colored glare shield as claimed in claim 1, wherein the film adhered by a self-adhesive material that has no optical effect upon vision and there is little or no residual adhesive on eyeglass lenses when removed.

10. Temporary colored glare shield as claimed in claim 1, wherein the film protects prescription eyeglass lenses by reducing scratches on lens surfaces.

11. Temporary colored glare shield as claimed in claim 1, wherein the film protects against UVB rays.
